(19) United States
(12) Patent Application Publication
(10) Pub. No.: US 2020/0104808 A1
(43) Pub. Date: Apr. 2, 2020

(54) Enterprise Wide Check Capture From A Single Foundational Software Engine

(71) Applicant: Alogent Corporation, Peachtree Corners, GA (US)

(72) Inventors: Jason SCHWABLINE, Geneva, FL (US); Ashish BHATIA, Suwanee, GA (US)

(73) Assignee: Alogent Corporation, Peachtree Corners, GA (US)

(21) Appl. No.: 16/588,258

(22) Filed: Sep. 30, 2019

Related U.S. Application Data
(60) Provisional application No. 62/739,429, filed on Oct. 1, 2018.

(51) Int. Cl. G06Q 20/04; G06Q 20/40; G07D 7/004; G07D 7/04

(52) U.S. Cl. CPC G06Q 20/042; G07D 7/04; G07D 7/004; G06Q 20/4016

(57) ABSTRACT

A system includes a processor and a memory coupled to the processor. The memory stores a database including a set of previous transactions and a set of business rules and instructions that, upon execution, cause the processor to receive a check image from a remote device, identify check information of the check image, and extract the check information from the check image. The instructions cause the processor to apply the set of business rules to the check information based on the remote device and validate the check information. The validation includes comparing the check information to the set of previous transactions, in response to the comparison identifying a duplicate transaction, determining the check image is fraudulent, and, in response to determining the check image is fraudulent, flagging the check image. The instructions cause the processor to transmit the check image and check information to the database for storage.

### CROSS REFERENCE

This application claims the benefit of U.S. Provisional Application 62/739,429, filed Oct. 1, 2018. The entire disclosure of the above application is incorporated herein by reference.

### FIELD

The present disclosure relates to financial transaction systems, methods, and devices, and, more particularly, to check capture and processing using a single software.

### BACKGROUND

Currently technology for the capturing and processing of checks into a financial services environment is accomplished through a multitude of methods, which match specific hardware components capturing the device. Hardware and consumer behavior changes and evolves frequently and financial institutions and their technology providers create specific methods per device to bring that data into the financial institution. This is inefficient, not scalable, costly, and open to fraud due to exposed gaps in time for the various pieces to be commingled into a single view. Many in the industry report to capture from a single “source”; however, there are still multiple interactions as opposed to a single efficient source that is software based.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system includes at least one processor and a memory coupled to the at least one processor. The memory stores a database including a set of previous transactions and a set of business rules and instructions that, upon execution, cause the at least one processor to receive a check image from a remote device, identify check information of the check image, and extract the check information from the check image. The instructions cause the at least one processor to apply the set of business rules to the check information based on the remote device and validate the check information. The validation includes comparing the check information to the set of previous transactions, in response to the comparison identifying a duplicate transaction, determining the check image is fraudulent, and, in response to determining the check image is fraudulent, flagging the check image. The instructions cause the at least one processor to transmit the check image and check information to the database for storage.

In other features, the check information includes at least one of: (i) a date, (ii) a signature, (iii) an amount, (iv) a payee, (v) a payor, and (vi) a magnetic ink character recognition line. In other features, applying the set of business rules to the check information based on the remote device includes determining a type of the remote device and identifying a subset of business rules of the set of business rules associated with the type of the remote device. In other features, the set of previous transactions includes check information for each performed interaction. In other features, flagging the check image includes generating and transmitting an alert to a second remote device associated with an entity. In other features, the check image is received from at least one of (i) an automated teller machine, (ii) a mobile device, and (iii) a teller machine.

In other features, comparing the check information to the set of previous transactions includes comparing the extracted check information to stored check information of each transaction of the set of previous transactions. In other features, identifying the duplicate transaction includes matching at least one parameter of the extracted check information to at least one parameter of the stored check information of each transaction of the set of previous transactions. In other features, the instructions, upon execution, cause the processor to accept the received check image as valid in response to the comparison not indicating a fraudulent transaction. In other features, each transaction of the set of previous transactions stores check information including at least one of: (i) a date, (ii) a signature, (iii) an amount, (iv) a payee, (v) a payor, and (vi) a magnetic ink character recognition line.

A method includes receiving a check image from a remote device and identifying check information of the check image. The method includes extracting the check information from the check image and applying a set of business rules to the check information based on the remote device. A database stores a set of previous transactions and the set of business rules. The method includes validating the check information by comparing the check information to the set of previous transactions and, in response to the comparison identifying a duplicate transaction, determining the check image is fraudulent. The method includes, in response to determining the check image is fraudulent, flagging the check image and transmitting the check image and check information to the database for storage.

In other features, the check information includes at least one of: (i) a date, (ii) a signature, (iii) an amount, (iv) a payee, (v) a payor, and (vi) a magnetic ink character recognition line. In other features, applying the set of business rules to the check information based on the remote device includes determining a type of the remote device and identifying a subset of business rules of the set of business rules associated with the type of the remote device. In other features, the set of previous transactions includes check information for each performed interaction. In other features, flagging the check image includes generating and transmitting an alert to a second remote device associated with an entity. In other features, the check image is received from at least one of (i) an automated teller machine, (ii) a mobile device, and (iii) a teller machine.

In other features, comparing the check information to the set of previous transactions includes comparing the extracted check information to stored check information of each transaction of the set of previous transactions. In other features, identifying the duplicate transaction includes matching at least one parameter of the extracted check information to at least one parameter of the stored check information of each transaction of the set of previous transactions. In other features, the method includes accepting the received check image as valid in response to the comparison not indicating a fraudulent transaction.

A non-transitory computer-readable medium storing processor-executable instructions, the instructions include receiving, from a remote device, a check image and identifying and extracting, using an interactive capture module, check information. The instructions include applying, using the interactive capture module, a set of business rules to the check information based on the remote device and validating, using the interactive capture module, the check information by accessing a database. The validating includes comparing the check information to a set of previous transactions included in the database, determining the check image is fraudulent in response to the comparison identifying a duplicate transaction included in the database, and flagging the check image in response to determining the check image is fraudulent. The instructions include transmitting the check image and check information to the database for storage.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram depicting a high-level check processing system.

FIG. 2 is a functional block diagram depicting a checking processing system using a plurality of check capture devices.

FIG. 3 is a flowchart depicting a check processing system.

In the drawings, reference numbers may be reused to identify similar and/or identical elements.

### DETAILED DESCRIPTION

The present disclosure provides a method of check capturing, interrogating, and processing using one application to apply a unified set of business rules to the captured check. In this way, additional methods of capturing a check for deposit can be incorporated into the system more easily. That is, using a single application that receives captured checks from all methods of check deposit allows for a more uniform system. Adding additional check capture methods would simply require the new method to capture the check and transmit the captured image to the application of the present disclosure.

Present systems and applications have separate install packages and require separate infrastructures and configurations. Further, previously, all applications had to be installed on the different capture device drivers on each workstation. Using interactive capture of the present application, a single install package is used for the system on a set of infrastructure servers. Therefore, the present application prevents the need to distribute a set of files to each workstation as the distribution is through a thin client.

An interactive capture module offers a single software foundation for all devices in the financial services ecosystem that capture checks with the same technology foundation instead of multiple technology foundations. The interactive capture module captures, interrogates, and processes checks from a mobile phone, teller station, remote ATM, tablets in a financial institution, as well as merchant capture channels, such as an in-branch tablet teller, back counter, etc. The interactive capture module will reduce costs in deployment models significantly, reduce fraud due to the items being in to multiple locations (which can otherwise only be remedied by the addition of another tool) and allow customers to access check deposit in a rapid fashion as opposed to lengthy deployment cycles that presently exist. The interactive capture module is also fully internationalized and can be localized to work worldwide.

An enterprise wide check capture foundational engine has taken the approach to eliminate independent pieces of software to capture checks and introduce them to the processing environment—for example, the interactive capture module. The enterprise wide check capture foundational engine moves all of the communications and interrogations into a single foundational layer that will exchange data using defined API rules no matter the origin of the check capture. In addition to the specific APIs for communication protocols, the enterprise wide check capture foundational engine can operate within the smallest to the largest financial institutions in the world, which will be a first for a single solution in the industry.

The interactive capture module will export formats into the necessary file or transaction types necessary, depending on the market consumer of geographical deployment. Working in tandem with other internal designs, the interactive capture module will eliminate any transaction reconciliation issues as well as batch processing of data. The flexibility of the enterprise wide check capture foundational engine is also new as most are created for a single market in the world. Moreover, processing and exporting through a single layer will expedite processing of funds in any market deployed while heavily reducing the hops via servers and internal communications, thus reducing the rate of failure while reducing costs as the same data and transactions will no longer need to pass through multiple software providers. Traditional, transactions passing through multiple software providers adds cost to each transaction, which is essentially passed on to the consumer at some point.

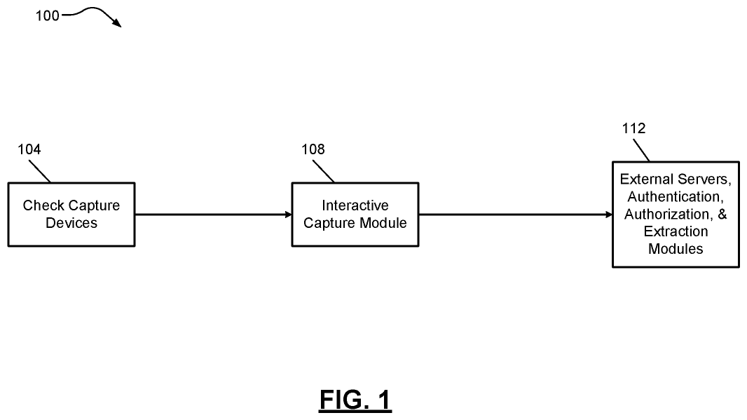

Now referring to FIG. 1, a functional block diagram depicting a high-level check processing system 100 is shown. For example, the check processing system 100 may be implemented as an enterprise wide check capture foundational engine, as described above. The check processing system 100 includes a plurality of check capture devices 104. Check capture devices 104 leverage a photo capturing function of the check capture devices 104 to capture an image of a check when a user is attempting to deposit the check. The check capture devices 104 also include devices used by a financial institution where the user can deposit the check.

The check capture devices 104 transmit a captured check or a photo of a check to an interactive capture module 108. The interactive capture module 108 can receive a captured check and process that captured check independent of what device captured and/or transmitted the check. The interactive capture module 108 may be centrally located at a financial institution or a server associated with the financial institution. The interactive capture module 108 can interrogate the captured check and extract data from the check.

In various implementations, after the interactive capture module 108 processes the check, the extracted information, as well as the original check, may be sent to external servers, authentication, authorization, and extraction modules 112. The external servers, authentication, authorization, and extraction modules 112 can further process the check and transmit the check to any necessary third-party. For example, using a mobile application, a user may be authenticated through the mobile application by logging on. Then, if the user is attempting to deposit information into an account, in response to the user selecting such an action, the system (and authentication, authorization, and extraction modules 112) determines whether the user is authorized to deposit in the selected account. Then, the user captures a photograph of the front and back of a check the user is depositing in the selected account. From the captured images, the check information is extracted from the check images of the front and back of the check.

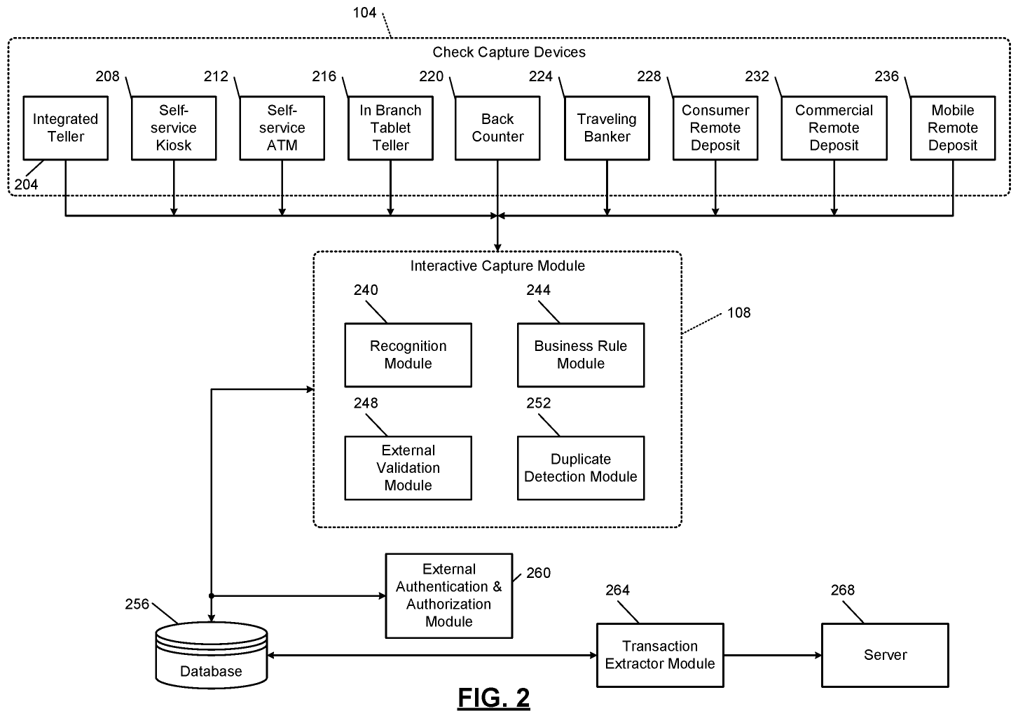

Referring now to FIG. 2, a functional block diagram depicting a checking processing system using a plurality of check capture devices 104 is shown. The plurality of check capture devices 104 include: an integrated teller 204 (teller service web service (TSWS), check scanner imaging, integration into a teller system, updated service to manage deployment), a self-service kiosk 208 (self-service web service (SSWS), kiosk performs imaging, kiosk integrator interfaces to SSWS), a self-service ATM 212 (SSWS, ATM performs imaging, ATM integrator can interface to AIC real time or in a post process), an in branch tablet teller 216 (TSWS, IP or USB check scanner, integrated to a teller system), a back counter 220 (TSWS, check scanner, integrated to a teller system, update service to manage deployment, handle larger sized transaction), a traveling banker 224 (TSWS or SSWS, check scanner or integrated camera, pseudo teller application, update service to manage deployment), a consumer remote deposit 228 (TSWS, flatbed scanner (TWAIN)—scanner service, single sign on to banking portal, update service to manage deployment), a commercial remote deposit 232 (TSWS, check scanner, single sign on to banking portal, update service to manage deployment), and a mobile remote deposit 236 (SSWS, integrated mobile camera, interface to mobile banking, image recognition on mobile or on third party server). For example, the TSWS is an API that can be used to process teller deposit transactions by interfacing with a check scanner to capture images, and the SSWS is an API that provides a simple mechanism to capture deposit transactions at self-service kiosks, tablets, or other mobile devices. Therefore, as described, the present application introduces the novel use of a single API regardless of the point of capture of, for example, a check. In various implementations, checks may be deposited at financial institutions using devices such as mobile computing devices, tablets, peripheral devices connected to a computing device—for example, a scanner, etc.

Additionally, mobile computing devices may be used remotely to deposit checks. Each of the computing devices mentioned previously may include a camera. The camera may be used to capture an image of the check, and an application installed on the computing device may ensure the quality of the image is satisfactory (for example, by only accepting a certain quality of image with respect to blurriness, the image including the entire check, etc.) and transmit the image to the interactive capture module 108.

The captured check is transmitted to the interactive capture module 108. The interactive capture module 108 includes a recognition module 240, which may identify a receipt of the check in various implementations. The recognition module 240 may also identify transaction information included on the check, such as check information, described below. The interactive capture module 108 may include a corresponding recognition module for each type of capture device. In this way, the interactive capture module 108 is compatible with each capture device and also functions as a single module capable of processing a check from each type of capture device.

The interactive capture module 108 may also include a business rule module 244. The business rule module 244 may contain a set of rules for receiving and depositing a check. Alternatively, the business rule module 244 may access the set of rules that are stored in the database 256. The database 256 is a multi-day repository of transaction data and images, includes in-channel duplicate detection, includes reporting and analytics, and clusters for resiliency. The business rules are defined independently according to the channel from which the check is acquired, for example, the teller, the mobile device, the automated teller machine (ATM), etc. Therefore, deposited checks are analyzed according to an original capture device. For example, if an item is captured on the teller line, business rules can be set up to correct any unreadable character in the code line as there is human interaction. However, the same cannot be applied to a check deposit originating from the mobile channel. Therefore, checks deposited through the mobile channel may not be error-corrected.

The business rule module 244 may also include a set of rules for processing the check. In various implementations, the business rule module 244 includes a separate set of rules for each type of capture device. The set of business rules may vary according to each capture device based on security requirements associated with each capture device as well as other considerations, such as variation of information included in the transaction. In various implementations, the business rule module 244 may have a common set of business rules applied to each check, creating a unified processing system as well as a single processing system.

The interactive capture module 108 may also include an external validation module 248. The external validation module 248 may also include a set of rules for verifying the authenticity of the check. Similar to the business rule module 244, the external validation module 248 may include a common set of rules to verify or validate the check. Additionally or alternatively the external validation module 248 may include a set of rules for each capture device. In various implementations, a set of rules included in the external validation module 248 may apply to a subset of the capture devices.

The interactive capture module 108 may also include a duplicate detection module 252. The duplicate detection module 252 may identify a strict duplicate check. In this way, if the same image of the same check is used multiple times, the duplicate detection module 252 will flag the check, requiring intervention by a financial institution. An item with the same routing number, account number, check serial number, and amount captured on a different processing date is flagged as a potential duplicate. The duplicate detection module 252 may also identify if the same check is being submitted through multiple capture devices or channels. The duplicate detection module 252 may also flag an attempted transaction or check deposit when check information from a deposited check matches a number of parameters from a recently deposited check, indicating potential fraud. Flagging a transaction does not necessarily halt or prevent the transaction, inconveniencing the user. Instead, flagging the transaction will indicate to the financial institution that the present transaction may be fraudulent, and the financial institution may want to take further action if an employee determines that the transaction suggests fraud.

The check and/or check information is transmitted from the interactive capture module 108 to a database 256 for storage. In various implementations, the recognition module 240 extracts the check information from the check image. The check information may include all information on the check, such as a routing number, an account number, a payor, payor address, a date the check was completed, a payor signature, an amount to be paid, a payee, magnetic ink character recognition (MICR) line, etc.

The database 256 is centralized and may include all transactions for an associated financial institution. The check and/or the check information may also be transmitted to an external authentication and authorization module 260. In various implementations, the external authentication and authorization module 260 may be a third-party that conducts fraud detection or may be a third-party that completes or further processes the transaction or the check deposit. For example, the external authentication and authorization module 260 may be another financial institution.

A transaction extractor module 264 may access check information or transaction information stored in the database 256. The transaction extractor module 264 is the service responsible for generation of output data and output files are in standard CDI format. The transaction extractor module 264 manages batching at extract time.

In various implementations, the transaction extractor module 264 manages transaction batching and generates output data of the transactions. Additionally, the transaction extractor module 264 may process each transaction individually and in real time. In various implementations, the transaction extractor module 264 may transmit the check image to a server 268 for routing to another financial institution or a third-party—for example, a clearing house.

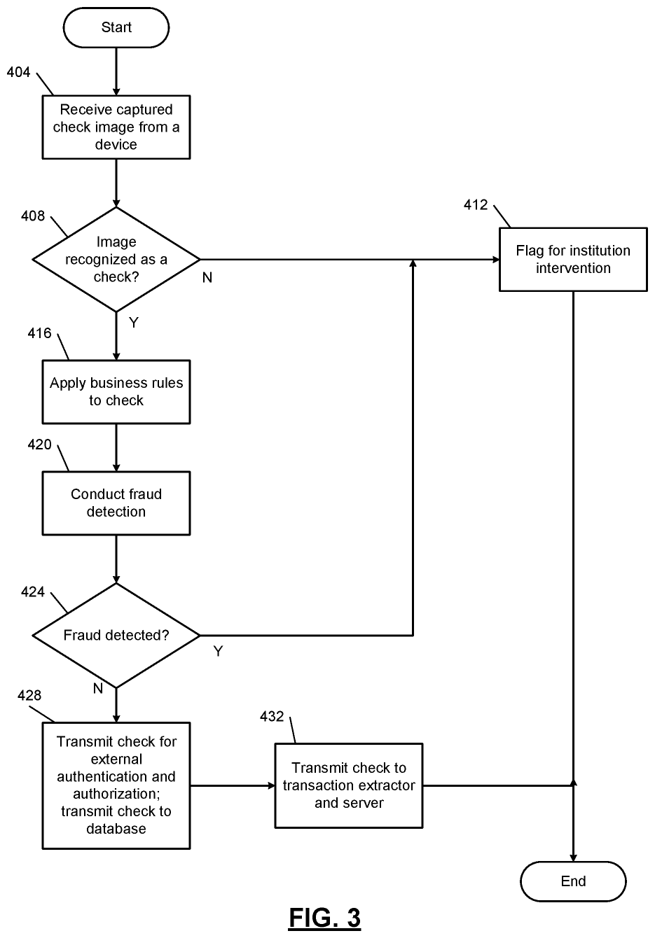

Now referring to FIG. 3, a flowchart depicting a check processing system is shown. Control begins at 404, where a captured check image is received from a device. The device may be one of the check capture devices described in FIG. 2. In various implementations, the check capture may be any type of financial transactions occurring between devices. For example, the check capture may be a financial transaction conducted on one of the devices and control may receive parameters of the transaction similar to check information. The transaction may be processed the same as a captured check is processed. Once the captured check image is received, control continues to 408 where control determines if the captured check image is recognized as a check. In various implementations, the device may determine whether the captured check image is recognized as a check. However, for proper processing, control may determine whether the captured check image is identifiable and, if not, control continues to 412 where the check is flagged for intervention by an associated financial institution. Once flagged, control ends. Otherwise, control continues to 416.

At 416, control applies a set of business rules to the check. As described previously, the set of business rules ensures appropriate processing of the check. Additionally, the set of business rules may be based on the capturing device. Once the set of business rules are applied to the check, control continues to 420 to conduct fraud detection. For example, fraud detection may include duplicate check detection or duplicate transaction detection. If fraud is detected, control proceeds to 412 to flag the transaction for intervention by the associated financial institution. Once flagged, control ends. Otherwise, control continues to 428.

At 428, control transmits the check for external authentication and authorization. Simultaneously, the check is transmitted to a central database where the check and the check information can be accessed by authorized modules. Control continues to 432 where the check is transmitted to a transaction extractor and a server. The transaction extractor may determine appropriate routing for additional check processing. Additionally, the transaction extractor may route the check to third-party institutions, for example, via the server. Once transmitted to the transaction extractor and server, the check processing is complete.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
at least one processor; and
a memory coupled to the at least one processor,
wherein the memory stores:
a database including a set of previous transactions and a set of business rules; and
instructions that, upon execution, cause the at least one processor to:
receive a check image from a remote device;
identify check information of the check image;
extract the check information from the check image;
apply the set of business rules to the check information based on the remote device;
validate the check information by:
comparing the check information to the set of previous transactions;
in response to the comparison identifying a duplicate transaction, determining the check image is fraudulent; and
in response to determining the check image is fraudulent, flagging the check image; and
transmit the check image and check information to the database for storage.

2. The system of claim 1 wherein the check information includes at least one of: (i) a date, (ii) a signature, (iii) an amount, (iv) a payee, (v) a payor, and (vi) a magnetic ink character recognition line.

3. The system of claim 1 wherein applying the set of business rules to the check information based on the remote device includes:
determining a type of the remote device; and
identifying a subset of business rules of the set of business rules associated with the type of the remote device.

4. The system of claim 1 wherein the set of previous transactions includes check information for each performed interaction.

5. The system of claim 1 wherein flagging the check image includes:
generating and transmitting an alert to a second remote device associated with an entity.

6. The system of claim 1 wherein the check image is received from at least one of (i) an automated teller machine, (ii) a mobile device, and (iii) a teller machine.

7. The system of claim 1 wherein comparing the check information to the set of previous transactions includes comparing the extracted check information to stored check information of each transaction of the set of previous transactions.

8. The system of claim 7 wherein identifying the duplicate transaction includes matching at least one parameter of the extracted check information to at least one parameter of the stored check information of each transaction of the set of previous transactions.

9. The system of claim 1 wherein the instructions, upon execution, cause the processor to:
accept the received check image as valid in response to the comparison not indicating a fraudulent transaction.

10. The system of claim 1 wherein each transaction of the set of previous transactions stores check information including at least one of: (i) a date, (ii) a signature, (iii) an amount, (iv) a payee, (v) a payor, and (vi) a magnetic ink character recognition line.

11. A method comprising:
receiving a check image from a remote device;
identifying check information of the check image;
extracting the check information from the check image;
applying a set of business rules to the check information based on the remote device, wherein a database stores a set of previous transactions and the set of business rules;
validating the check information by comparing the check information to the set of previous transactions;
in response to the comparison identifying a duplicate transaction, determining the check image is fraudulent;
in response to determining the check image is fraudulent, flagging the check image; and
transmitting the check image and check information to the database for storage.

12. The method of claim 11 wherein the check information includes at least one of: (i) a date, (ii) a signature, (iii) an amount, (iv) a payee, (v) a payor, and (vi) a magnetic ink character recognition line.

13. The method of claim 11 wherein applying the set of business rules to the check information based on the remote device includes:
determining a type of the remote device; and
identifying a subset of business rules of the set of business rules associated with the type of the remote device.

14. The method of claim 11 wherein the set of previous transactions includes check information for each performed interaction.

15. The method of claim 11 wherein flagging the check image includes:
generating and transmitting an alert to a second remote device associated with an entity.

16. The method of claim 11 wherein the check image is received from at least one of (i) an automated teller machine, (ii) a mobile device, and (iii) a teller machine.

17. The method of claim 11 wherein comparing the check information to the set of previous transactions includes comparing the extracted check information to stored check information of each transaction of the set of previous transactions.

18. The method of claim 17 wherein identifying the duplicate transaction includes matching at least one parameter of the extracted check information to at least one parameter of the stored check information of each transaction of the set of previous transactions.

19. The method of claim 11 further comprising:
accepting the received check image as valid in response to the comparison not indicating a fraudulent transaction.

20. A non-transitory computer-readable medium storing processor-executable instructions, the instructions comprising:
receiving, from a remote device, a check image;
identifying and extracting, using an interactive capture module, check information;
applying, using the interactive capture module, a set of business rules to the check information based on the remote device;
validating, using the interactive capture module, the check information by accessing a database, wherein the validating includes:
comparing the check information to a set of previous transactions included in the database;
determining the check image is fraudulent in response to the comparison identifying a duplicate transaction included in the database; and
flagging the check image in response to determining the check image is fraudulent; and
transmitting the check image and check information to the database for storage.
